(19) United States
(12) Patent Application Publication
(10) Pub. No.: US 2005/0062203 A1
(43) Pub. Date: Mar. 24, 2005

(54) Release agents, plastics moldings and processes for their production

(76) Inventors: Peter Haas, Haan (DE); Michael Schneider, Odenthal (DE)

Correspondence Address: BAYER MATERIAL SCIENCE LLC, 100 BAYER ROAD, PITTSBURGH, PA, 15205, US

(21) Appl. No.: 10/940,567

(22) Filed: Sep. 14, 2004

(30) Foreign Application Priority Data
Sep. 18, 2003 (DE) 10343099.7

(51) Int. Cl. B29C 31/00

(52) U.S. Cl. 264/338; 264/240; 106/38.22

(57) ABSTRACT

The present invention provides release agents and plastics moldings and a process for their production using particular additives which reduce the concentration of undesirable, potentially harmful substances in the edge zone and on the surface of the molding, without adversely influencing the other mechanical properties.

### FIELD OF THE INVENTION

The present invention relates to release agents and to plastics moldings with a low content of noxious substances and a process for their production using particular additives which reduce the concentration of undesirable, potentially harmful substances in the edge zone and on the surface of the molding, without adversely influencing the other mechanical properties.

### BACKGROUND OF THE INVENTION

High molecular weight synthetic substances (polymers), such as, for example, plastics, synthetic resins, fibers and elastomers, play an exceptionally important role in industry. Plastics are processed, for example, by cold or hot shaping, in particular by rolling, injection molding or press molding. In the “hot press molding process”, the material is introduced into the press as pellets or granules and heated; the material, which has become plastic, fills all the hollow spaces of the press mold exactly and retains its shape after cooling. Films are cast e.g. by processing of solutions. The production of plastics moldings can also be carried out by reaction of reaction mixtures, as well as by processing of finished polymers in the form of granules or the like. For example, the majority of polyurethanes, in particular polyurethane foams, are prepared by the one-stage or one-shot process, in which the raw material components employed are metered and mixed exactly according to a given recipe and the reactive mixture formed is then introduced from the mixing chamber into shaping devices. Another process is the two-stage process or prepolymer process, which is of importance e.g. for the preparation of elastomers.

During the production of plastics moldings, re-formation of monomers may occur due to thermal cleavage of the polymer. In the case of numerous polymers, these usually very reactive monomers are to be classified as harmful. Furthermore, the molding can also contain traces of other reaction by-products or cleavage products or additives, such as catalysts, stabilizers, emulsifiers, blowing agents etc., which may be harmful.

For health reasons, it is desirable to keep the concentration of such potentially harmful substances as low as possible. Various methods have been proposed for this. In addition to elimination of the undesirable substances by after-treatment of the molding, which is time-consuming and increases production costs, the addition to the reaction mixture or to the polymer, during processing, of substances which bond the undesirable substances chemically is recommended above all others.

The teaching of GB-A 1 565 124 is to add a so-called scavenger compound for aromatic amines, namely TDA (toluylenediamine, diaminotoluene) to the individual reactive components in the production of polyurethane foams. It can be seen from the examples that the addition of 0.5 to 8 wt. % of aliphatic diisocyanate is effective although only the addition of ≧5 wt. % of the expensive aliphatic diisocyanates reveals significant successes. However, the addition of considerable contents of aliphatic polyisocyanates adversely influences the mechanical and physical properties of the polyurethane foams based on aromatic polyisocyanates.

DE-A 199 19 826, DE-A 199 19 827, DE-A 199 28 675, DE-A 199 28 676, DE-A 199 28 687, DE-A 199 28 688 and DE-A 199 28 689 disclose a large number of less expensive additives and auxiliary substances from various classes of chemical compounds which are said to reduce the intermediate formation of primary aromatic diamines, such as MDA (methylenediphenylenediamine) or TDA during the production of flexible polyurethane foams. Here also, 1 to 6 wt. % of the auxiliary substance is added to the reactive components.

A disadvantage of the addition of such auxiliary substances which act as “scavengers” for undesirable substances in the plastics formulation is the occurrence of significant changes in the mechanical or chemico-physical specification of the end product. Such changes may necessitate a new or further development of the composition of the formulation or of the polymer raw material. This applies all the more as considerable amounts of the auxiliary substance must usually be added to effectively eliminate the undesirable substances.

In the production of plastics moldings, interactions occur in the contact zone between the plastics composition and the mold wall, so that the composition of the plastic in this edge zone (skin) differs from the composition in the inner region (core)—in some cases only in the range of traces. For example, immediately after the preparation of polyisocyanate polyaddition products based on aromatic polyisocyanates, the aromatic amines on which the polyisocyanate is chemically based is detectable in the foam in only trace concentrations. These aromatic amines are intermediately formed formally by hydrolysis of the isocyanate groups of the polyisocyanate employed with carbon dioxide being released. In flexible molded polyurethane foams, the content of these aromatic amines in the edge zone (skin) is higher than in the inside of the molding (core).

It is therefore particularly important to reduce the concentration of the undesirable substances in the edge zone of the plastics molding. This is also necessary because the surfaces of the plastics moldings, especially in the case of objects in daily use, are the immediate contact surfaces to the processor and also later to the user.

It is known from WO 03/045656 that the concentration of undesirable, in particular potentially harmful substances on the surfaces and in the edge zone of plastics moldings can be reduced effectively if release agents which are made from one or more additives which react with the undesirable substances and in this way act as “scavengers” for these undesirable substances are employed during production of the moldings.

The contents of amine components in the edge zone are indeed lowered by the release agent compositions described in WO 03/045656, but these are still present to a considerable extent.

### SUMMARY OF THE INVENTION

The present invention therefore reduces the content of amine components, in particular in the edge zone of plastics moldings, as completely as possible without adversely influencing the mechanical/physical properties of the moldings.

It has been possible to achieve this reduction by adding particular additives to the isocyanate component during the preparation of the polyurethane and/or by employing them as a release agent or as an additive in the release agent during production of the moldings.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages and so forth in the specification are to be understood as being modified in all instances by the term “about.”

The present invention provides external mold release agents which contain 5 to 100 wt. %, more preferably 10 to 100 wt. % of at least one component chosen from anhydrides of carboxylic acids having identical or different hydrocarbon radicals, wherein at least one of the hydrocarbon radicals contains 8 to 40 carbon atoms, more preferably 12 to 40 carbon atoms, and polyanhydrides of carboxylic acids and polycarboxylic acids, preferably dicarboxylic acids, having identical or different hydrocarbon radicals, wherein at least one of the hydrocarbon radicals contains 8 to 40 carbon atoms, more preferably 12 to 40 carbon atoms.

The present invention also provides plastics moldings of polyurethane which contain carboxylic acid amides in the edge zone.

The present invention also provides a process for the production of the plastics moldings from polyurethane, in which
a) the mold is pretreated with an external mold release agent which contains 0 to 100 wt. % of at least one component (X) chosen from anhydrides of carboxylic acids having identical or different hydrocarbon radicals, wherein at least one of the hydrocarbon radicals contains 8 to 40 carbon atoms, more preferably 12 to 40 carbon atoms, and polyanhydrides of carboxylic acids and polycarboxylic acids, preferably dicarboxylic acids, having identical or different hydrocarbon radicals, wherein at least one of the hydrocarbon radicals contains 8 to 40 carbon atoms, more preferably 12 to 40 carbon atoms,
b) the amount of reaction components and auxiliary substances and additives required for formation of the plastics moldings is introduced into the mold, the isocyanate component containing 0 to 25 wt. %, more preferably 0 to 10 wt. %, most preferably 1 to 10 wt. % of at least one component (X) chosen from anhydrides of carboxylic acids having identical or different hydrocarbon radicals, wherein at least one of the hydrocarbon radicals contains 8 to 40 carbon atoms, more preferably 12 to 40 carbon atoms, and polyanhydrides of carboxylic acids and polycarboxylic acids, preferably dicarboxylic acids, having identical or different hydrocarbon radicals, wherein at least one of the hydrocarbon radicals contains 8 to 40 carbon atoms, more preferably 12 to 40 carbon atoms, and the molding is formed, and
c) the molding is removed from the mold,
   wherein either the external mold release agent or the isocyanate component or both contain at least one component (X).

Component (X) can be used as an external mold release agent or as part of an external mold release agent and as an additive to the isocyanate component in the production of polyurethane moldings.

The anhydrides of carboxylic acids are derived in particular from oleic acid, linoleic acid, ricinoleic acid, tall oil, stearic acid, palmitic acid, soya oil fatty acid, cerotic acid and montan acid. The further hydrocarbon radical of the anhydride can have a shorter carbon chain and be derived, for example, from acetic acid, formic acid, propionic acid, benzoic acid etc. Anhydrides with the acids of phosphorus, sulfur or carbonic acid are also possible.

For processes in which the plastic is processed on shaping surfaces (press molds, rolls etc.), it is important that the end product can be detached from the surface or removed from the mold without damage. The shaping surfaces are therefore coated with a release agent between the individual processing steps (in the case of molds) or continuously (in the case of rolls). This prevents the plastics molding from sticking to the shaping surface.

According to the invention, one or more components (X) which act as “scavengers” with respect to the substances which intermediately occur undesirably, e.g. in the case of flexible molded polyurethane foams chemically bond aromatic amines in the edge zone, can be added to a commercially available release agent. It has surprisingly been found that such modified release agents suppress the formation of these undesirable substances in the edge zone of plastics moldings effectively and virtually quantitatively, with the original action of the release agent (ensuring ease of release from the mold, i.e. damage-free removal of the plastics molding from the mold and the desired pore structure) being retained. In particular, in the production of flexible molded polyurethane foams, the high concentrations of aromatic amines in the skin compared with the core both directly after the production and after storage can be markedly reduced in this way.

Because the cell structure is not impaired by the additives mentioned (component X), these additives can also be employed in the polyol and/or the isocyanate component.

The additives can also be employed in the preparation of polyurethane polyaddition products without further external release agents.

The additives employed according to the invention have a symmetric or asymmetric structure, such as e.g. oleic acid anhydride, stearic acid anhydride, polyricinoleic acid anhydride, adipic acid-oleic acid anhydride, oleic acid-acetic acid anhydride, adipic acid-ricinoleic acid polyanhydride ester, oleylacetyl anhydride, oleylformyl anhydride, oleylbenzoyl anhydride, acetylstearic acid anhydride, acetic acid montanoyl anhydride, acetic acid-ricinoleic acid anhydride acetyl ester, ester anhydrides based on dicarboxylic acids, such as adipic acid, and monocarboxylic acids, such as oleic acid or ricinoleic acid, or maleic acid-oleic acid anhydride.

Anhydrides based on at least one long-chain carboxylic acid and carbonic acid or pyrocarbonic acid, such as dioleyl carbonate, dioleyl pyrocarbonate, oleyl acetyl carbonate and oleyl acetyl pyrocarbonate, can also be employed.

The polyurethanes are prepared from polyisocyanates and long-chain polyether-polyols, which are prepared by base-catalyzed polyaddition or by means of DMC catalysis (EP-A 1 194 468), with the co-use of blowing agents, catalysts, stabilizers and optionally further auxiliary substances and additives.

In addition to the long-chain polyether-polyols, further compounds containing hydroxyl groups (polyols) can be employed in the polyol formulation for the preparation of the polyurethanes. These polyols, which are known per se, are described in detail e.g. in Gum, Riese & Ulrich (eds.): “Reaction Polymers”, Hanser Verlag, Munich 1992, p. 66-96 and G. Oertel (eds.): “Kunststoffhandbuch, volume 7, Polyurethane”, Hanser Verlag, Munich 1993, p. 57-75. Examples of suitable polyols are to be found in the literature references mentioned and in U.S. Pat. No. 3,652,639, U.S. Pat. No. 4,421,872 and U.S. Pat. No. 4,310,632.

Polyols which are preferably employed are polyether-polyols (in particular poly(oxyalkylene)-polyols) and polyester-polyols.

The polyether-polyols are prepared by known methods, preferably by base-catalyzed polyaddition of alkylene oxides on to polyfunctional starter compounds containing active hydrogen atoms, such as e.g. alcohols or amines. Examples which may be mentioned are: ethylene glycol, diethylene glycol, 1,2-propylene glycol, 1,4-butanediol, hexamethylene glycol, bisphenol A, trimethylolpropane, glycerol, pentaerythritol, sorbitol, sucrose, degraded starch, water, methylamine, ethylamine, propylamine, butylamine, aniline, benzylamine, o- and p-toluidine, α,β-naphthylamine, ammonia, ethylenediamine, propylenediamine, 1,4-butylenediamine, 1,2-, 1,3-, 1,4-, 1,5- and/or 1,6-hexamethylenediamine, o-, m- and p-phenylenediamine, 2,4- and 2,6-toluylenediamine, 2,2′-, 2,4- and 4,4′-diaminodiphenylmethane and diethylenediamine.

Alkylene oxides which are employed are, preferably, ethylene oxide, propylene oxide, butylene oxide and mixtures thereof. The build-up of the polyether chains by alkoxylation can be carried out only with a monomeric epoxide, but can also take place randomly or also block-wise with two or three different monomeric epoxides.

Processes for the preparation of such polyether-polyols are described in “Kunststoffhandbuch, volume 7, Polyurethane”, in “Reaction Polymers” and e.g. in U.S. Pat. No. 1,922,451, U.S. Pat. No. 2,674,619, U.S. Pat. No. 1,922,459, U.S. Pat. No. 3,190,927 and U.S. Pat. No. 3,346,557.

Such polyether-polyols can also be employed for the production of flexible polyurethane foams with the co-use of filler-containing polyols, such as e.g. polymer-polyols (styrene/acrylonitrile copolymers) or polyurea dispersion polyols etc.

Methods for the preparation of polyester-polyols are also well-known and are described e.g. in the two literature references mentioned above (“Kunststoffhandbuch, volume 7, Polyurethane”, “Reaction Polymers”). The polyester-polyols are in general prepared by polycondensation of polyfunctional carboxylic acids or derivatives thereof, such as e.g. acid chlorides or anhydrides, with polyfunctional hydroxyl compounds.

Examples of polyfunctional carboxylic acids which can be used are: adipic acid, phthalic acid, isophthalic acid, terephthalic acid, oxalic acid, succinic acid, glutaric acid, azelaic acid, sebacic acid, fumaric acid or maleic acid.

Examples of polyfunctional hydroxyl compounds which can be used are: ethylene glycol, diethylene glycol, triethylene glycol, 1,2-propylene glycol, dipropylene glycol, 1,3-butanediol, 1,4-butanediol, 1,6-hexanediol, 1,12-dodecanediol, neopentylglycol, trimethylolpropane, triethylolpropane or glycerol.

The preparation of the polyester-polyols can furthermore also be carried out by ring-opening polymerization of lactones (e.g. caprolactone) with diols and/or triols as starters.

A crosslinking component can additionally be added in the preparation of the polyurethanes according to the invention. Diethanolamine, triethanolamine, glycerol, trimethylolpropane (TMP), adducts of such crosslinking compounds with ethylene oxide and/or propylene oxide having an OH number of <1,000 or also glycols having a number-average molecular weight of ≦1,000 e.g. can be used as such crosslinking agents. Triethanolamine, glycerol, TMP or lower EO and/or PO adducts thereof are particularly preferred.

Known auxiliary substances, additives and/or flameproofing agents can furthermore optionally be added. Auxiliary substances in this context are understood as meaning, in particular, catalysts and stabilizers which are known to those skilled in the art. Melamine e.g. can be employed as a flameproofing agent.

Catalysts which are optionally to be added are known to those skilled in the art. Non-limiting examples which may be mentioned are tertiary amines, such as triethylamine, tributylamine, N-methylmorpholine, N-ethyl-morpholine, N,N,N′,N′-tetramethylethylenediamine, pentamethyldiethylenetriamine and higher homologues (DE-A 26 24 527 and DE-A 26 24 528), 1,4-diaza-bicyclo[2,2,2]octane, N-methyl-N′-dimethylaminoethylpiperazine, bis(dimethylaminoalkyl)-piperazines (DE-A 26 36 787), N,N-dimethylbenzylamine, N,N-dimethylcyclohexylamine, N,N-diethylbenzylamine, bis(N,N-diethylaminoethyl) adipate, N,N,N′,N′-tetramethyl-1,3-butanediamine, N,N-dimethyl-β-phenyl-ethyl-amine, 1,2-dimethylimidazole, 2-methylimidazole, monocyclic and bicyclic amidines (DE-A 17 20 633), bis(dialkylamino)alkyl ethers (U.S. Pat. No. 3,330,782, DE-A 10 30 558, DE-A 18 04 361 and DE-A 26 18 280) as well as tertiary amines containing amide groups (preferably formamide groups), according to DE-A 25 23 633 and DE-A 27 32 292. Possible catalysts are also Mannich bases, which are known, from secondary amines, e.g. dimethylamine, and aldehydes, preferably formaldehyde, or ketones, such as acetone, methyl ethyl ketone or cyclohexanone, and phenols, such as phenol, nonylphenol or bisphenols. Tertiary amines which contain hydrogen atoms which are active towards isocyanate groups and can be employed as a catalyst are e.g. triethanolamine, triisopropanolamine, N-methyl-diethanolamine, N-ethyl-diethanolamine, N,N-dimethylethanolamine, reaction products thereof with alkylene oxides, such as propylene oxide and/or ethylene oxide, as well as secondary-tertiary amines according to DE-A 27 32 292. Sila-amines with carbon-silicon bonds such as are described e.g. in DE-A 12 29 290, e.g. 2,2,4-trimethyl-2-silamorpholine and 1,3-diethyl-aminomethyltetramethyldisiloxane, are furthermore possible as catalysts. Nitrogen-containing bases, such as tetraalkylammonium hydroxides, and furthermore alkali metal hydroxides, such as sodium hydroxide, alkali metal phenolates, such as sodium phenolate, or alkali metal alcoholates, such as sodium methylate, are also possible as catalysts. Hexahydrotriazines can also be employed as catalysts (DE-A 17 69 043). The reaction between NCO groups and Zerewitinoff-active hydrogen atoms is also greatly accelerated by lactams and azalactams, an associate between the lactam and the compound with acid hydrogen first being formed. Such associates and their catalytic action are described in DE-A 20 62 286, DE-A 20 62 289, DE-A 21 17 576, DE-A 21 29 198, DE-A 23 30 175 and DE-A 23 30 211. Organometallic compounds, in particular organic tin compounds, can also be used according to the invention as catalysts. Possible organotin compounds are, in addition to sulfur-containing compounds, such as di-n-octyl-tin mercaptide (DE-A 17 69 367; U.S. Pat. No. 3,645,927), preferably tin(II) salts of carboxylic acids, such as tin(II) acetate, tin(II) octoate, tin(II) ethylhexanoate and tin(II) laurate, and tin(IV) compounds, e.g. dibutyltin oxide, dibutyltin dichloride, dibutyltin diacetate, dibutyltin dilaurate, dibutyltin maleate or dioctyltin diacetate. All the above-mentioned catalysts can of course be employed as mixtures. Combinations of organometallic compounds and amidines, aminopyridines or hydrazinopyridines (DE-A 24 34 185, DE-A 26 01 082 and DE-A 26 03 834) are of particular interest in this context. So-called polymeric catalysts such as are described in DE-A 42 18 840 can also be employed as catalysts. These catalysts are reaction products, in the alkali metal salt form, of alcohols which are trifunctional or more than trifunctional and have (number-average) molecular weights of 92 to 1,000 with intramolecular carboxylic acid anhydrides. The reaction products have (as a statistical average) at least 2, preferably 2 to 5 hydroxyl groups and at least 0.5, preferably 1.0 to 4 carboxylate groups, the counter-ions to the carboxylate groups being alkali metal cations. As can be seen from the content of carboxylate groups, the “reaction products” of the starting components can also be mixtures of true reaction products with excess amounts of alcohols. Suitable polyhydric alcohols for the preparation of the reaction products are, for example, glycerol, trimethylolpropane, sorbitol, pentaerythritol, mixtures of such polyhydric alcohols, alkoxylation products of alcohols having (number-average) molecular weights of 92 to 1,000 or of mixtures of such alcohols, propylene oxide and/or ethylene oxide in any desired sequence or in a mixture, but preferably exclusively propylene oxide, being employed in the alkoxylation. Suitable intramolecular carboxylic acid anhydrides for the preparation of the reaction products are, for example, maleic acid anhydride, phthalic acid anhydride, hexahydrophthalic acid anhydride, succinic acid anhydride, pyromellitic acid anhydride or any desired mixtures of such anhydrides. Maleic acid anhydride is particularly preferably employed. Further representatives of catalysts to be used and details of the mode of action of the catalysts are described in Vieweg and Höchtlen (eds.): Kunststoff-Handbuch, volume VII, Carl-Hanser-Verlag, Munich 1966, p. 96-102.

The catalysts are preferably employed in amounts of about 0.001 to 10 wt. %, based on the total amount of compounds having at least two hydrogen atoms which are reactive towards isocyanates.

Further additives which are optionally employed are surface-active additives, such as emulsifiers and foam stabilizers. Possible emulsifiers are e.g. the sodium salts of castor oil-sulfonates or salts of fatty acids with amines, such as oleic acid-diethylamine or stearic acid-diethanolamine. Alkali metal or ammonium salts of sulfonic acids, such as, for example, of dodecylbenzenesulfonic acid or dinaphthylmethanedisulfonic acid, or of fatty acids, such as ricinoleic acid, or of polymeric fatty acids can be co-used as surface-active additives.

Foam stabilizers which are employed are, above all, polyether-siloxanes, specifically water-soluble representatives. These compounds are in general built up such that a copolymer of ethylene oxide and propylene oxide is bonded to a polydimethylsiloxane radical. Such foam stabilizers are described e.g. in U.S. Pat. No. 2,834,748, U.S. Pat. No. 2,917,480 and U.S. Pat. No. 3,629,308. Polysiloxane/polyoxyalkylene copolymers which are branched several times via allophanate groups, in accordance with DE-A 25 58 523, are of particular interest.

Further possible additives are reaction retardants, e.g. acid-reacting substances, such as hydrochloric acid or organic acid halides, and furthermore cell regulators which are known to those skilled in the art, such as paraffins or fatty alcohols or dimethylpolysiloxanes, as well as pigments or dyestuffs and flameproofing agents which are known per se, e.g. trichloroethyl phosphate, tricresyl phosphate or ammonium phosphate and polyphosphate, furthermore stabilizers against ageing and weathering influences, plasticizers and fungistatically and bacteriostatically acting substances as well as fillers, such as barium sulfate, kieselguhr, carbon black or prepared chalk.

Further examples of surface-active additives and foam stabilizers as well as cell regulators, reaction retardants, stabilizers, flame-retardant substances, plasticizers, dyestuffs and fillers as well as fungistatically an bacteriostatically active substances which are optionally to be co-used according to the invention and details of the mode of use and action of these additives are described in Vieweg and Höchtlen (eds.): Kunststoff-Handbuch, volume VII, Carl-Hanser-Verlag, Munich 1966, p.103-113.

Any of the blowing agents known in polyurethane foam production are suitable as the blowing agent component which is optionally to be employed. Possible organic blowing agents are e.g. acetone, ethyl acetate, halogen-substituted alkanes, such as methylene chloride, chloroform, ethylidene chloride, vinylidene chloride, monofluorotrichloromethane, chlorodifluoromethane and dichlorodifluoromethane, furthermore butane, hexane, heptane or diethyl ether, and possible inorganic blowing agents are e.g. air, CO₂ or N₂O. A blowing action can also be achieved by addition of compounds which decompose at temperatures above room temperature with the splitting off of gases, for example nitrogen, e.g. azo compounds, such as azodicarboxamide or azoisobutyric acid nitrile. Hydrogen-containing fluoroalkanes (HCFCs) and lower alkanes, such as e.g. butane, pentane, isopentane, cyclopentane, hexane and iso-hexane, optionally in a mixture with one another and/or with the addition of water, are particularly preferably used as blowing agents. Further examples of blowing agents and details of the use thereof are described in Vieweg and Höchtlen (eds.): Kunststoff-Handbuch, volume VII, Carl-Hanser-Verlag, Munich 1966, p. 108 et seq., p. 453 et seq. and p. 507 et seq. Preferably, however, water or CO₂ is the sole blowing agent.

Possible polyisocyanates are aliphatic, cycloaliphatic, araliphatic, aromatic and heterocyclic isocyanates, preferably di- or polyisocyanates, such as are described in Justus Liebigs Annalen der Chemie 562 (1949) 75, for example those of the formula Q(NCO)ₙ, in which n denotes an integer from 2 to 4, more preferably 2, and Q denotes an aliphatic hydrocarbon radical having 2 to 18, more preferably 6 to 12 Carbon atoms, a cycloaliphatic hydrocarbon radical having 4 to 15, more preferably 5 to 10 Carbon atoms, an aromatic hydrocarbon radical having 6 to 15, more preferably 6 to 13 Carbon atoms, or an araliphatic hydrocarbon radical having 8 to 15, more preferably 8 to 13 Carbon atoms. The polyisocyanates which are readily available, e.g. 1,6-hexamethylene-diisocyanate, isophorone-diisocyanate (IPDI), 4,4′-dicyclohexamethylenemethane-diisocyanate (H₁₂-MDI), durol-diisocyanate, 1,4-di-(isocyanatomethyl)cyclohexane, 1,3-bis-(isocyanato-1-methylethyl)-benzene (“TMXDI”), 2,4- and 2,6-toluylene-diisocyanate and any desired mixtures of these isomers (“TDI”, e.g. DESMODUR T80, Bayer AG), polyphenyl-polymethylene-polyisocyanates, such as are prepared by aniline-formaldehyde condensation and subsequent phosgenation (“crude MDI”, e.g. DESMODUR 44V20L, Bayer AG) and polyisocyanates containing carbodiimide groups, urethane groups, allophanate groups, isocyanurate groups, urea groups or biuret groups (“modified polyisocyanates”), in particular those modified polyisocyanates which are derived from 2,4- and/or 2,6-toluylene-diisocyanate or from 4,4′- and/or 2,4′-diphenylmethane-diisocyanate or from 1,6-hexamethylene-diisocyanate and/or isophorone-diisocyanate. The organic di- and polyisocyanates can be employed individually or in the form of their mixtures. TMXDI and cycloaliphatic diisocyanates are particularly preferred, in particular IPDI, 1,4-di-(isocyanatomethyl)cyclohexane and H₁₂-MDI (e.g. DESMODUR W, Bayer AG).

Mold release agents are processing additives which reduce the forces of adhesion between two surfaces adjacent to one another (e.g. molding and mold), i.e. “sticking” of the surfaces is prevented by the mold release agent forming an easily separated film between the two surfaces. Mold release agents are used in the form of dispersions (emulsions or suspensions), sprays, pastes, powders and permanent, usually stoved release agent films. For plastics processing and molded foam production, silicones (in the form of oils, oil emulsions in water, fats, resins), waxes (substantially naturally occurring or synthetic paraffins with or without function groups), metal soaps, fats and polymers are used above all. For the choice of the particular best release agent from the processing aspect, not only is fundamental knowledge of the PU system necessary, the type of mold material, the nature of the surface thereof and the molding geometry are also important.

Suitable release agents are commercially available, for example, from ACMOS Chemie GmbH & Co. (e.g. ACMOS 180-52), RATEC International GmbH (e.g. PURA 1448H), GORAPUR (e.g. GORAPUR RT 835C, GORAPUR LK 149, GORAPUR LK 888, GORAPUR LH 525, GORAPUR LH 157A, GORAPUR RT 2130B, GORAPUR RT 1126B), Marbo Italia S. A. (e.g. MARBO WR 95101/A) and Productos Concentrol S. A. (e.g. CONCENTROL WB33A).

If a release agent which has at least one of the components (X) according to the invention having an anhydride structure in a content of 10 wt. % up to 100 wt. %, more preferably 15 wt. % to 90 wt. %, most preferably 50 wt. % to 90 wt. % is used in the preparation of the polyurethane moldings, the edge zone of the molding has an almost not detectable concentration of the aromatic amine on which the polyisocyanate used is chemically based. These components (X) have proven to be especially effective in the production of flexible molded polyurethane foam components in which aromatic polyisocyanates are employed as the isocyanate component.

The process for the production of plastics moldings, preferably plastics moldings of reactive plastics, in particular polyurethanes, particularly preferably molded polyurethane foams, in particular flexible molded polyurethane foams and integral foam, is particularly preferably carried out such that
a) the mold is pretreated with the release agent according to the invention,
b) the plastics composition required for formation of the molding is introduced into the pretreated mold and the molding is formed, and
c) the molding formed is removed.

Suitable molds for the production of plastics moldings are known in those skilled in the art. As a rule, such molds are made of metal, for example steel (e.g. black plate), precision casting alloy or aluminum (e.g. sheet aluminum or cast aluminum), or of plastic (e.g. epoxy resin or fiber-reinforced polyester). The moldings can be produced in open or closed, heated or unheated molds, depending on the plastic used and the molding to be produced.

The mold is treated with the release agent according to the invention in any manner known to those skilled in the art, e.g. by spraying on, with compressed air into the opened mold, or by brushing on with a brush, sponge or cloth. The amount of release agent is less important than is a uniform application.

The plastics composition required for formation of the molding is introduced into the pretreated mold and the moldings is formed. This is effected by the processes familiar to the those skilled in the art. For the production of foams, e.g. PU foams, polystyrene foams (EPS), styrene copolymer foams, polyisocyanurate foams, polycarbodiimide foams, PVC foams, polycarbonate foams, polyolefin foams, polymethacrylimide foams, polyamide foams, ABS foams and phenolic and urea resin foams (UF foams), above all injection molding, reaction injection molding (RIM or RRIM) and blow molding or film blowing are suitable.

The invention is to be explained in more detail, but is not to be limited, by the following examples.

### EXAMPLES

To determine the concentration of aromatic amines on the surface of moldings of flexible molded polyurethane foam, the skin zone (edge layer, thickness 1 mm) was separated off from the freshly produced moldings after a defined storage time (storage in the dark and in contact with air) and analyzed by means of the ISOPA I.I.I. detection method for TDA (ISOPA I.I.I. ref. 11397, “robust method for the determination of toluenediamine content of flexible foams”) and MDA (ISOPA I.I.I. ref. 11399, “robust method for the determination of the diaminodiphenylmethane content of flexible polyurethane foams”). The TDA and MDA contents stated in the examples correspond to the absolute contents (in ppm) in the edge layer of the molded foam component.

Standard recipe AA

Production of a flexible molded polyurethane foam based on MDI:

A polyol mixture (A component) was prepared from the starting substances described below:

| | |
|---|---|
| 50 parts by wt. | of a polyether-polyol having a hydroxyl |
| | number (OHN) of 35 mg KOH/g, an |
| | average functionality of 2.6 and an |
| | ethylene oxide (EO)/propylene oxide |
| | (PO) ratio of 14/86 with 75% of |
| | primary OH groups. |
| 50 parts by wt. | of a polyether-polyol having a hydroxyl |
| | number (OHN) of 28 mg KOH/g, an average |
| | functionality of 2.4 and an ethylene oxide |
| | (EO)/propylene oxide (PO) ratio of 14/86 |
| | with 80% of primary OH groups. |
| 3.45 parts by wt. | of water |
| 0.26 part by wt. | of blowing catalyst (DABCO BL-11, |
| | Air Products) |
| 0.35 part by wt. | of gel catalyst (DABCO 33LV, |
| | Air Products) |
| 0.53 part by wt. | of diethanolamine (DEOA) |
| 0.3 part by wt. | of silicone stabilizer |
| | (TEGOSTAB B 8715LF, Degussa- |
| | Goldschmidt AG) |
| 1.5 parts by wt. | of a polyether-polyol having |
| | a hydroxyl number (OHN) of 37 mg KOH/g, |
| | an average functionality of 2.9 and an |
| | ethylene oxide (EO)/propylene oxide (PO) |
| | ratio of 72/28 with 80% of |
| | primary OH groups. |

This A component was mixed at a temperature of 25° C. with a mixture of 18 wt. % pMDI and 82 wt. % of a mixture of 2,4′-MDI and 4,4′-MDI in a ratio of 2.3:1 (NCO content 32.5 wt. %; B component). For production of moldings, the mixture was introduced into a 9.5 liter mold which was temperature-controlled at 60° C. and treated with a release agent (ACMOS 180-52, ACMOS Chemie GmbH & Co.) and foamed there. The amount of the mixture was such that the resulting moldings have a molding density of 55 kg/m³. For production of moldings with an index of 80 (recipe AA), the weight ratio of A component to B component was 100:45. The mold was closed with a lid and introduced into a press or clamp to counteract the foaming pressure and to keep the mold closed. After 5 minutes, the lid was removed and the foam was worked by mechanical compression until the foam was open-celled, i.e. shrink-free. MDA contents of the skin zone of the moldings:

| | | | 4,4′-MDA | 2,4′-MDA | 2,2′-MDA |
|---|---|---|---|---|---|
| Standard | Index | Storage time | [ppm] | [ppm] | [ppm] |
| AA | 80 | 24 h | 1.8 | 63 | 5.4 |
| AA | 80 | 7 days | 0.3 | 5.4 | 0.9 |

Mechanical properties of the moldings (measured after 7 days):

| | | | CLD | Tensile | Elongation | CS | CS |
|---|---|---|---|---|---|---|---|
| | | Density | 4/40 | stress | at break | 50% | 75% |
| Standard | Index | [kg/m³] | [kPa] | [kPa] | [%] | [%] | [%] |
| AA | 80 | 50.1 | 4.3 | 106 | 113 | 6.3 | 7.9 |

CLD 4/40: Compression load deflection, 4th cycle at 40% deformation in accordance with DIN EN ISO 3386-1-98.
CS: Compression set at 50% or 75% deformation (DIN EN ISO 1856).
Tensile stress, elongation at break in accordance with DIN EN ISO 1798.

### Examples 1A-C

Flexible molded foam components were produced analogously to standard recipe AA. Instead of with commercially available release agents, the mold was pretreated in the conventional manner with a mixture of the amount in wt. % of ACMOS 180-52 stated in the table and the amount in wt. % of the additive according to the invention stated in the table. The results are summarized in the following tables.

MDA contents of the skin zone of the moldings:

| | | Build-up of the | | | | |
|---|---|---|---|---|---|---|
| | | release agent in wt. % | | | | |
| | | ACMOS | | 4,4′-MDA | 2,4′-MDA | 2,2′-MDA |
| Ex. | Index | 180-52 | AMS | [ppm] | [ppm] | [ppm] |
| 1A | 80 | 75 | 25 | 0.5 | 3.8 | 4.8 |
| | | | AMS 1 | | | |
| 1B | 80 | 50 | 50 | <0.2 | <0.2 | <0.2 |
| | | | AMS 1 | | | |
| 1C | 80 | 25 | 75 | <0.2 | 1.6 | 2.4 |
| | | | AMS 5 | | | |

AMS 1: Amine scavenger 1,
AMS 5: Amine scavenger 5,
Storage time was 24 h

Mechanical properties of the moldings (measured after 7 days):

| | | | CLD | Tensile | Elongation | CS | CS |
|---|---|---|---|---|---|---|---|
| | | Density | 4/40 | stress | at break | 50% | 75% |
| Ex. | Index | [kg/m³] | [kPa] | [kPa] | [%] | [%] | [%] |
| 1A | 80 | 52.3 | 4.6 | 112 | 118 | 6.1 | 7.8 |
| 1B | 80 | 51.4 | 4.4 | 108 | 122 | 6.3 | 8.1 |
| 1C | 80 | 51.8 | 4.5 | 106 | 124 | 6.3 | 8.0 |

CLD 4/40: Compression load deflection, 4th cycle at 40% deformation in accordance with DIN EN ISO 3386-1-98.
CS: Compression set at 50% or 75% deformation (DIN EN ISO 1856).
Tensile stress, elongation at break in accordance with DIN EN ISO 1798.

### Example 1D

1 wt. % of the amine scavenger 2 (AMS 2) was added to the isocyanate component of standard recipe AA and the mixture was foamed, commercially available Acmos® 180-52 being used as the release agent. For production of mouldings with an index of 80 (standard AA), the weight ratio of A component to B component is 100:45.4. The results are summarized in the following table.

MDA contents of the skin zone of the mouldings:

| | | Build-up of the | | | | |
|---|---|---|---|---|---|---|
| | | release agent in | | | | |
| | | wt. % | | 4,4′- | 2,4′- | |
| | | Acmos | | MDA | MDA | 2,2′-MDA |
| Ex. | Index | 180-52 | AMS | [ppm]^{a} | [ppm]^{a)} | [ppm]^{a)} |
| 1D | 80 | 100 | — | <0.2 | 21.5 | 6 |
| | (MDI + 1% AMS 2) | | | | | |

AMS 2: Amine scavenger 2,
^{a)}Storage time 24 h

Standard recipe BB

Production of a flexible molded polyurethane foam based on TDI:

A polyol mixture (A component) was prepared from the starting substances described below:

| | |
|---|---|
| 70 parts by wt. | of a polyol having a hydroxyl number (OHN) of 29 mg |
| | KOH/g, an average functionality of 3.4 and an |
| | ethylene oxide (EO)/propylene oxide (PO) |
| | ratio of 18/82 with 85% of |
| | primary OH groups. |
| 30 parts by wt. | of a polyol having a hydroxyl number (OHN) of 20 mg |
| | KOH/g, an average functionality of 2.7 and an |
| | ethylene oxide (EO)/propylene oxide (PO) |
| | ratio of 20/80 with 85% of primary OH |
| | groups and a filler content (polymerized |
| | styrene/acrylonitrile in a ratio of 7:4) |
| | of 43 wt. %. |
| 3.0 parts by wt. | of water |
| 0.12 part by wt. | of blowing catalyst (DABCO BL-11, Air Products) |
| 0.28 part by wt. | of gel catalyst (DABCO 33LV, Air Products) |
| 0.8 part by wt. | of diethanolamine (DEOA) |
| 0.8 part by wt. | of silicone stabilizer (TEGOSTAB B 8719LF, |
| | Degussa-Goldschmidt AG) |

This A component was mixed at a temperature of 25° C. with TDI having an NCO content of 48.3 wt. % (B component: DESMODUR T80, Bayer AG). For production of moldings, the mixture was introduced into a 9.5 liter mold which was temperature-controlled at 60° C. and treated with a release agent (ACMOS 180-52, ACMOS Chemie-GmbH & Co.) and foamed there. The amount of the mixture here was such that the resulting moldings have a molding density of 43 kg/m³. For production of moldings with an index of 80 (standard BB), the weight ratio of A component to B component was 100:27. The mold was closed with a lid and introduced into a press or clamp to counteract the foaming pressure and to keep the mold closed. After 6 minutes, the lid was removed and the foam was worked by mechanical compression until the foam was open-celled, i.e. shrink-free.

TDA contents of the skin zone of the moldings:

| | | 2,4-TDA | 2,6-TDA |
|---|---|---|---|
| Standard | Index | [ppm]^{a)} | [ppm]^{a)} |
| BB | 80 | 5.3 | 363 |

^{a)}Storage time 24 h

Mechanical properties of the moldings (measured after 7 days):

| | | | CLD | Tensile | Elongation | CS | CS |
|---|---|---|---|---|---|---|---|
| | | Density | 4/40 | stress | at break | 50% | 75% |
| Standard | Index | [kg/m³] | [kPa] | [kPa] | [%] | [%] | [%] |
| BB | 80 | 42 | 2.8 | 153 | 124 | 4.8 | 7.3 |

CLD 4/40: Compression load deflection, 4th cycle at 40% deformation in accordance with DIN EN ISO 3386-1-98.
CS: Compression set at 50% or 75% deformation (DIN EN ISO 1856).
Tensile stress, elongation at break in accordance with DIN EN ISO 1798.

### Examples 2A-G

Flexible molded foam components were produced analogously to standard recipe BB. Instead of pretreatment with commercially available release agents, the mold was pretreated in the conventional manner with a mixture of ACMOS 180-52 and various concentrations of the additives according to the invention. The results are summarized in the following table.

TDA contents of the skin zone of the moldings:

| | | ACMOS 180-52 | AMS 2 | 2,4-TDA | 2,6-TDA |
|---|---|---|---|---|---|
| Ex. | Index | [wt. %] | [wt. %] | [ppm]^{a)} | [ppm]^{a)} |
| 2 A | 80 | 50 | 50 | 0.4 | 90.4 |
| 2 B | 80 | 25 | 75 | 0.2 | 20.6 |

AMS 2: Amine scavenger 2
^{a)}Storage time 24 hours

10 wt. % of the amine scavenger 2 (AMS 2) was additionally added to the isocyanate component of standard recipe BB and a component was produced analogously to Example 2, the release agent according to composition 2 B being used.

TDA contents in the edge zone of the moldings (storage time 24 h)

| | | ACMOS | | | |
|---|---|---|---|---|---|
| | | 180-52 | AMS 2 | 2,4-TDA | 2,6-TDA |
| Ex. | Index | [wt. %] | [wt. %] | [ppm] | [ppm] |
| 2 C | 80 | 25 | 75 | <0.2 | <0.2 |
| | (TDI + 10% AMS2) | | | | |

Due to the use of the amine scavengers in the release agent and/or in the isocyanate, the content of amines was below the detection limit. Measurement of the amine content of the edge zone approx. 2 hours after the production of the foam already showed amine contents below the detection limit.

1 wt. % or 10 wt. % respectively of an amine scavenger (AMS) was added to the isocyanate component of standard recipe BB and the mixture was foamed, commercially available Acmos® 180-52 being used as the release agent. For production of mouldings with an index of 80 (standard BB), the weight ratio of A component to B component is 100:29.6. The results are summarized in the following table.

TDA contents in the edge zone of the mouldings (storage time 24 hours)

| | | Acmos ® 180-52 | 2,4-TDA | 2,6-TDA |
|---|---|---|---|---|
| Ex. | Index | [wt. %] | [ppm] | [ppm] |
| 2 D | 80 | 100 | <0.2 | 0.4 |
| | (TDI + 10% AMS3) | | | |
| 2 E | 80 | 100 | <0.2 | 0.4 |
| | (TDI + 10% AMS4) | | | |
| 2 F | 80 | 100 | <0.2 | 0.4 |
| | (TDI + 2.5% AMS6) | | | |
| 2 G | 80 | 100 | 2.1 | 168 |
| | (TDI + 1% AMS2) | | | |

AMS2: Amine scavenger 2
AMS3: Amine scavenger 3
AMS4: Amine scavenger 4
AMS6: Amine scavenger 6

Standard recipe CC

Production of a flexible molded polyurethane foam based on TDI/MDI:

A polyol mixture (A component) was prepared from the starting substances described below:

| | |
|---|---|
| 55 parts by wt. | of a polyol having a hydroxyl number (OHN) of 28 mg |
| | KOH/g, an average functionality of 2.4 and an |
| | ethylene oxide (EO)/propylene oxide (PO) |
| | ratio of 18/82 with 85% of primary |
| | OH groups. |
| 45 parts by wt. | of a polyol having a hydroxyl number (OHN) of 29 mg |
| | KOH/g, an average functionality of 2.6 and an |
| | ethylene oxide (EO)/propylene oxide (PO) |
| | ratio of 18/82 with 85% of primary OH |
| | groups and a filler content (polymerized |
| | styrene/acrylonitrile in a ratio of 2:3) of 20 wt. %.. |
| 3.6 parts by wt. | of water |
| 0.1 part by wt. | of blowing catalyst (DABCO BL-11, Air Products) |
| 0.35 part by wt. | of gel catalyst (POLYCAT 77, Air Products) |
| 1.0 part by wt. | of silicone stabilizer (TEGOSTAB B 8719LF, |
| | Degussa-Goldschmidt AG) |
| 1.0 part by wt. | of a polyether-polyol having a hydroxyl number |
| | (OHN) of 37 mg KOH/g, an average functionality |
| | of 2.9 and an ethylene oxide (EO)/propylene |
| | oxide (PO) ratio of 72/28 with 80% |
| | of primary OH groups. |

This A component was mixed at a temperature of 25° C. with a 4:1 mixture of TDI (DESMODUR T80, Bayer AG) and polymeric MDI (DESMODUR 44V20L, Bayer AG) (B component, NCO content of the mixture 44.8 wt. %). For production of moldings, the mixture was introduced into a 9.5 liter mold which was temperature-controlled at 60° C. and treated with a release agent (ACMOS 180-52, ACMOS Chemie-GmbH & Co.) and foamed there. The amount of the mixture was such that the resulting moldings have a molding density of 47 kg/m³. For production of moldings with an index of 80 (standard CC), the weight ratio of A component to B component was 100:32.1. The mold was closed with a lid and introduced into a press or clamp to counteract the foaming pressure and to keep the mold closed. After 5 minutes, the lid was removed and the foam was worked by mechanical compression until the foam was open-celled, i.e. shrink-free.

TDA and MDA contents of the skin zone of the moldings:

| | | 2,4- | 2,6- | | | |
|---|---|---|---|---|---|---|
| | | TDA | TDA | 4,4′-MDA | 2,4′-MDA | 2,2′-MDA |
| Standard | Index | [ppm]^{a)} | [ppm]^{a)} | [ppm]^{a)} | [ppm]^{a)} | [ppm]^{a)} |
| CC | 80 | 8.8 | 562.4 | 118.7 | 15.2 | 1.5 |

^{a)}Storage time 24 hours

Mechanical properties of the moldings (measured after 7 days):

| | | | CLD | Tensile | Elongation | CS | CS |
|---|---|---|---|---|---|---|---|
| | | Density | 4/40 | stress | at break | 50% | 75% |
| Standard | Index | [kg/m³] | [kPa] | [kPa] | [%] | [%] | [%] |
| CC | 80 | 46.3 | 3.5 | 173 | 152 | 7.0 | 10.1 |

CLD 4/40: Compression load deflection, 4th cycle at 40% deformation in accordance with DIN EN ISO 3386-1-98.
CS: Compression set at 50% or 75% deformation (DIN EN ISO 1856).
Tensile stress, elongation at break in accordance with DIN EN ISO 1798.

### Example 3

Flexible molded foam components were produced analogously to standard recipe CC. 10 wt. % of amine scavenger 2 (AMS 2) was added to the isocyanate component of standard recipe CC and the mixture was foamed. For production of moldings with an index of 80 (standard CC), the weight ratio of A component to B component is 100:35.3. The results are summarized in the following tables.

TDA and MDA contents of the skin zone of the moldings:

| | | 2,4-TDA | 2,6-TDA | 4,4′-MDA | 2,4′-MDA | 2,2′-MDA |
|---|---|---|---|---|---|---|
| Ex. | Index | [ppm]^{a)} | [ppm]^{a)} | [ppm]^{a} | [ppm]^{a)} | [ppm]^{a)} |
| 3 | 80 | <0.2 | 4.0 | <0.2 | 0.5 | 1.4 |

^{a)}Storage time 24 h

Mechanical properties of the moldings (measured after 7 days):

| | | | CLD | Tensile | Elongation | CS | CS |
|---|---|---|---|---|---|---|---|
| | | Density | 4/40 | stress | at break | 50% | 75% |
| Ex. | Index | [kg/m³] | [kPa] | [kPa] | [%] | [%] | [%] |
| 3 | 80 | 45.8 | 3.4 | 180 | 177 | 10.3 | 17.9 |

Preparation of the amine scavengers (AMS) according to the invention:

### AMS 1 (acetyl stearate)

118 g acetyl chloride were added dropwise to a suspension of 459 g sodium stearate in 5,000 ml dimethylacetamide at 60° C. The mixture was heated at 100° C. for 3 hours, cooled down to 20° C. and filtered off with suction from the sodium chloride formed. The filtrate was concentrated in vacuo at 110° C. Yield: 400 g acetyl stearate, acid number 330 mg KOH/g after complete saponification.

### AMS 2 (oleic acid anhydride)

565 g oleic acid and 405 g acetic acid anhydride were heated under reflux for 3 hours and the mixture was concentrated, a bottom temperature of 175° C. being reached. The mixture was concentrated and drawn to dryness under 0.5 mbar at 150° C. Yield: 546 g oleic acid anhydride, acid number 195 mg KOH/g after complete saponification.

### AMS 3

565 g oleic acid, 146 g adipic acid and 408 g acetic acid anhydride were heated under reflux for 3 hours, a bottom temperature of 180° C. being reached. The mixture was concentrated and drawn to dryness under 0.5 bar. Yield: 670 g, melting point 60-65° C., acid number 322 mg KOH/g after complete saponification.

### AMS 4

723 g ricinoleic acid and 1,000 acetic acid anhydride were heated under reflux for 3 hours and concentrated up to a temperature of 170° C., the product finally being treated under a vacuum under 0.5 mbar. Yield: 754 g, acid number 112 mg KOH/g after saponification.

### AMS 5

745 g ricinoleic acid, 146 g adipic acid and 1,020 g acetic acid anhydride were heated under reflux at 140° C. for 3 hours and concentrated up to a temperature of 150° C. Finally, the product was drawn to dryness under 0.5 mbar. Yield: 900 g, melting point 70° C., acid number 221 mg KOH/g after saponification.

### AMS 6

Phthalic acid anhydride

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the production of polyurethane plastics moldings, comprising:
pretreating a mold with an external mold release agent comprising 0 to 100 wt. % of at least one component (X) chosen from
carboxylic acids having identical or different hydrocarbon radicals, wherein at least one of the hydrocarbon radicals contains 8 to 40 carbon atoms, and
polyanhydrides of carboxylic acids and polycarboxylic acids, having identical or different hydrocarbon radicals, wherein at least one of the hydrocarbon radicals contains 8 to 40 carbon atoms;
introducing an amount of reaction components, auxiliary substances and additives required for formation of the molding into the pretreated mold, with an isocyanate component comprising up to about 25 wt. % of at least one of the component (X) and;
forming the molding and removing the molding from the mold,
wherein the external mold release agent optionally comprises at least one component (X).

2. An external mold release agent chosen from
carboxylic acids having identical or different hydrocarbon radicals, wherein at least one of the hydrocarbon radicals contains 8 to 40 carbon atoms, and
polyanhydrides of carboxylic acids and polycarboxylic acids, having identical or different hydrocarbon radicals, wherein at least one of the hydrocarbon radicals contains 8 to 40 carbon atoms.

3. An external mold release agent chosen from
carboxylic acids having identical or different hydrocarbon radicals, wherein at least one of the hydrocarbon radicals contains 12 to 40 carbon atoms, and
polyanhydrides of carboxylic acids and polycarboxylic acids, having identical or different hydrocarbon radicals, wherein at least one of the hydrocarbon radicals contains 12 to 40 carbon atoms.

4. In a process for the production of polyurethane moldings, the improvement comprising including at least one component (X) chosen from
carboxylic acids having identical or different hydrocarbon radicals, wherein at least one of the hydrocarbon radicals contains 8 to 40 carbon atoms, and
polyanhydrides of carboxylic acids and polycarboxylic acids, having identical or different hydrocarbon radicals, wherein at least one of the hydrocarbon radicals contains 8 to 40 carbon atoms
as part of an external mold release agent and as an additive to the isocyanate component.
